(19) United States
(12) Patent Application Publication
(10) Pub. No.: US 2017/0221130 A1
(43) Pub. Date: Aug. 3, 2017

(54) Shopping Cart Communication System

(71) Applicant: Wal-Mart Stores, Inc., Bentonville, AR (US)

(72) Inventors: Larry A. Kraus, Bella Vista, AR (US); Anthony G. Wind, III, Gravette, AR (US); Lawrence J. Duerkes, Springdale, AR (US)

(21) Appl. No.: 15/420,363

(22) Filed: Jan. 31, 2017

Related U.S. Application Data
(60) Provisional application No. 62/289,605, filed on Feb. 1, 2016.

(51) Int. Cl. G06Q 30/06

(52) U.S. Cl. CPC G06Q 30/0633; G06Q 30/0641; H04L 67/10

(57) ABSTRACT

Methods and systems are provided for operating a shopping cart communication system. The methods and systems are configured to receive, at an operator terminal of a first shopping cart, operator identifying information. The methods and systems are also configured to generate operator data based on the operator identifying information. The methods and systems are also configured to automatically transmit instructions to configure the graphic user interface of a display device of a second shopping cart to render an image for display to the operator of the first shopping cart, the image comprising a visual representation of the operator data. The methods and systems are also configured to display the rendered image on the display device of the second shopping cart.

### CROSS-REFERENCE TO RELATED PATENT APPLICATIONS

This application claims priority to U.S. Provisional Application No. 62/289,605 filed on Feb. 1, 2016, the contents of the application is hereby incorporated by reference in its entirety.

### FIELD OF TECHNOLOGY

The present disclosure relates generally to shopping carts and more particularly to shopping cart communication systems.

### BACKGROUND

Conventionally, shopping carts are baskets mounted on top of wheels. Such carts are incapable of interaction or communication therebetween.

### BRIEF DESCRIPTION OF THE DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a block diagram showing a system for a shopping cart communication system in accordance with various embodiments.

FIG. 2A is a block diagram showing a system for a shopping cart communication system having a central server in accordance with various embodiments.

FIG. 2B is a schematic diagram of an example shopping environment using the shopping cart communication system of FIG. 2A in accordance with various embodiments.

FIG. 3 is a side view of an exemplary shopping cart including a display device in accordance with various embodiments.

FIG. 4 is a flow diagram illustrating a method for using a shopping cart communication system in accordance with various embodiments.

FIG. 5 is an example computational device block diagram depicting various components which can be used to implement various of the disclosed embodiments.

FIG. 6 is an example computational device block diagram depicting various components which can be used to implement various of the disclosed embodiments in a distributed system.

### DETAILED DESCRIPTION

Methods and systems are provided herein for shopping cart communication systems. The methods and systems, in accordance with various embodiments, are configured to receive, at an operator terminal of a first shopping cart, operator identifying information associated with an operator of the first shopping cart. The methods and systems can also be configured to generate operator data associated with the operator, based on the operator identifying information. The methods and systems can also be configured to automatically transmit, in response to receiving the operator identifying information at the first shopping cart, instructions to configure the graphic user interface of a display device of a second shopping cart to render an image for display to the operator of the first shopping cart, the image including a visual representation of the operator data. The methods and systems can also be configured to display the rendered image on the display device of the second shopping cart.

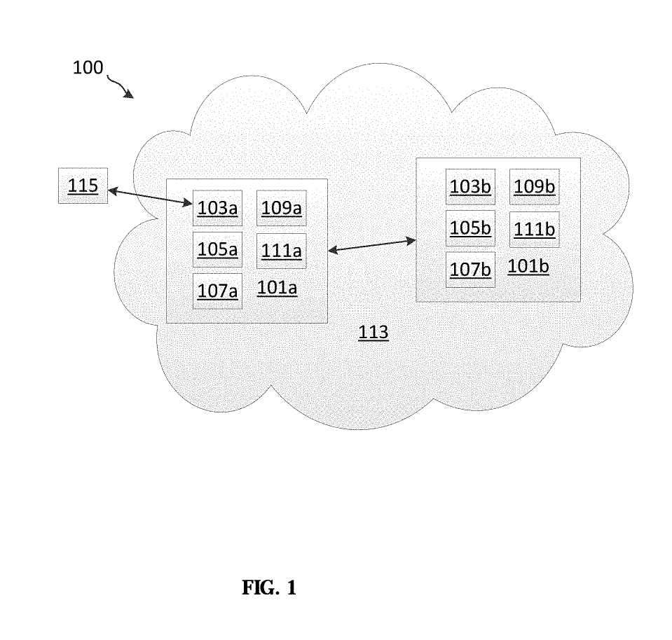

Referring now to FIG. 1, a shopping cart communication system 100 includes a first shopping cart 101a in electronic communication with a second shopping cart 101b. In accordance with various embodiments, the first and second shopping carts 101a, 101b can directly communicate via a communication device 107a, 107b included in the first and second shopping carts 101a, 101b, respectively, or can include first and second nodes of a distributed network 113. The first and second shopping carts 101a, 101b can each, in accordance with various embodiments, include one or more of an operator terminal 103a, 103b for interfacing with an operator, a display device 105a, 105b for rendering images for display to the operator of a different one of the first or second shopping carts, the communication device 107a, 107b for communicating with other carts 101a, 101b (e.g., directly or via the distributed network 113), and a location device 109a, 109b for determining a relative location of the first shopping cart 101a to the second shopping cart 101b. In accordance with various embodiments, the first and second shopping carts 101a, 101b each can include a product identification device 111a, 111b for detecting placement of a product into a respective one of the first and second shopping carts 101a, 101b.

The first and second shopping carts 101a, 101b can include, for example, retail/grocery shopping carts, aircraft trolleys, hand pushcarts, hand trucks, dollies, mail carts, any other suitable shopping cart, or combinations thereof. The first shopping cart 101a includes an operator terminal 103a for receiving operator identifying information from an operator of the first shopping cart 101a. The second shopping cart includes a display device 105b for rendering an image for display to the operator of the first shopping cart 101a in response to instructions received from the operator terminal 103a of the first shopping cart 101a. In accordance with various embodiments, each of the first and second shopping carts 101a, 101b can include an operator terminal 103a, 103b and a display device 105a, 105b.

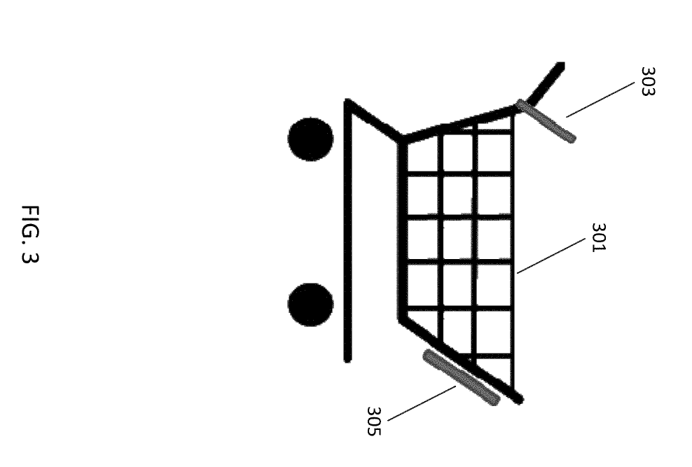

For example, referring now to FIG. 3, a retail shopping cart 301, in accordance with various embodiments, can include an operator terminal 303 facing an operator of the shopping cart 301 and a display device 305 positioned on a front surface (i.e., opposite the operator) of the shopping cart 301 for displaying an image to an operator of a different shopping cart.

Referring again to FIG. 1, in accordance with various embodiments, the first and second shopping carts 101a, 101b can be two of a plurality of shopping carts associated with the shopping cart communication system 100. In accordance with various embodiments, the first and second shopping carts 101a, 101b can directly communicate via a communication device 107a, 107b included in the first and second shopping carts 101a, 101b or can include first and second nodes of a distributed network 113.

The operator terminal 103a, 103b, in accordance with various embodiments, can include a touchscreen device, a smartphone, a tablet, a laptop, a docking station for pairing with an operator device 115, a near field communications (NFC) device for pairing with an operator device 115, a Bluetooth® device for pairing with an operator device 115, other suitable devices for receiving an operator input, or combinations thereof. In accordance with various embodiments, one or more of the communication device 107a, 107b, the location device 109a, 109b, or the product identification device 111a, 111b can be incorporated into the operator terminal 103a, 103b or can be separate devices therefrom.

The communication device 107a, 107b in accordance with various embodiments, can include, for example, a radio frequency (RF) transceiver, a near-field communication (NFC) device, a Bluetooth® transceiver, a built-in network adapter, a network interface card, a Personal Computer Memory Card International Association (PCMCIA) network card, a card bus network adapter, a wireless network adapter, a USB network adapter, a modem, or any other device suitable for interfacing with any type of network capable of communication and performing the operations described herein.

The location device 109a, 109b, in accordance with various embodiments, can include a global positioning system (GPS) device, a proximity sensor, a triangulation sensor, an inertial navigation system, a laser rangefinder, a long range navigation (LORAN) system, a radio frequency identification (RFID) device or system (e.g., at least one of an RFID tag or an RFID transceiver), any other suitable system for determining a relative location of the first and second carts 101a, 101b, or combinations thereof. The location device 109a, 109b can be used, in accordance with various embodiments, to detect a relative location and movement direction of another one of the shopping carts 101a, 101b.

The product identification device 111a, 111b, in accordance with various embodiments, can include a radio frequency identification (RFID) device, a weight sensor, a motion sensor, a barcode scanner, a product checklist presented to the operator at the operator terminal 103a, 103b, any other suitable device for identifying a presence or type of product in the first or second shopping cart 101a, 101b, or combinations thereof.

The display device 105a, 105b, in accordance with various embodiments, can include a LED monitor, a LCD monitor, a television, a CRT monitor, a touchscreen, a computer monitor, a touchscreen monitor, a screen or display of a mobile device (such as but not limited to, a smartphone, a tablet, or an electronic book), and/or any other display device. The display device 105a, 105b can be positioned in any suitable location on a respective one of the first or second shopping carts 101a, 101b including, for example, a front surface (e.g., a vertical surface positioned opposite from the operator as shown in FIG. 3 with reference to display device 305), a side surface, or on a mount extending from the respective one of the first or second shopping carts 101a, 101b, and each positioned for displaying an image to an operator of a different shopping cart.

In accordance with various embodiments, an operator of the first shopping cart 101a can input operator identifying information at the operator terminal 103a of the first shopping cart 101a to associate the first shopping cart 101a with the operator. The operator terminal 103a can, in response to receiving the operator identifying information, generate or receive operator data associated with the operator. Operator data can include, for example, an electronic shopping list, operator purchase history, operator preferences, operator demographic information, operator appointment information, any other data associated with the operator of the first cart, or combinations thereof.

The operator terminal 103a of the first shopping cart 101a, based on the operator data, can automatically transmit instructions to the display device 105b of the second shopping cart 101b to display an image that is configured for the operator of the first shopping cart 101a. For example, in accordance with various embodiments, an operator can request to link an operator device 115 with the operator terminal 103a of the first shopping cart 101a and enter operator identifying information to associate the operator with the first shopping cart 101a. The operator terminal 103a can, in accordance with various embodiments, retrieve a shopping list from the operator device 115 and, based on the shopping list, determine an in-store location of each item on the list. If the operator terminal 103a detects (e.g., based on data associated with the location device 109a of the first shopping cart 101a) that the operator has passed by or is near to the in-store location of an item on the shopping list, the operator terminal 103a can use the location device 109a to detect at least one proximately located shopping cart.

The location device 109a can, in accordance with various embodiments, detect that the second shopping cart 101b is located nearby and a directionality of movement of the second shopping cart 101b. If the location device 109a determines that the second shopping cart is nearby and moving in a direction relative to the first shopping cart 101a such that the display device 105b of the second shopping cart 101b is facing or otherwise within a line-of-sight of the operator of the first shopping cart 101a, the operator device 103a of the first shopping cart 101a can instruct, via the communications device 107a of the first shopping cart 101a, the display device 105b of the second shopping cart 101b to display a notification to the operator of the first shopping cart that a particular item on the shopping list is located nearby. Similarly, the operator terminal 103a of the first shopping cart 101a can, based on operator data, instruct the display device 105b of the second shopping cart 101b to display any suitable imagery or notifications including, for example, operator-specific advertising, product location, notification of sale items, notification of in-store automotive repair status, item locations, or any other imagery, notifications, or information.

Advantageously, displaying information directed to an operator of the first shopping cart 101a on a display device of the second shopping cart 101b permits the operator to continue looking outward from the first shopping cart 101a while operating. This configuration improves operator safety and convenience because, rather than requiring the operator to look down at an operator-facing display of the first shopping cart 101a, the operator is able to continue focusing on the products, other shopping carts, and other persons in the aisle or area the operator of the first shopping cart 101a is moving through.

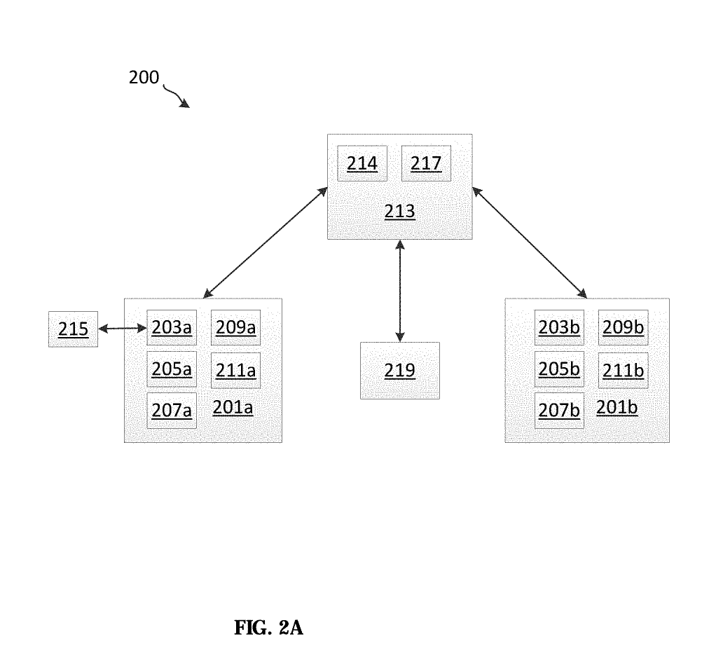

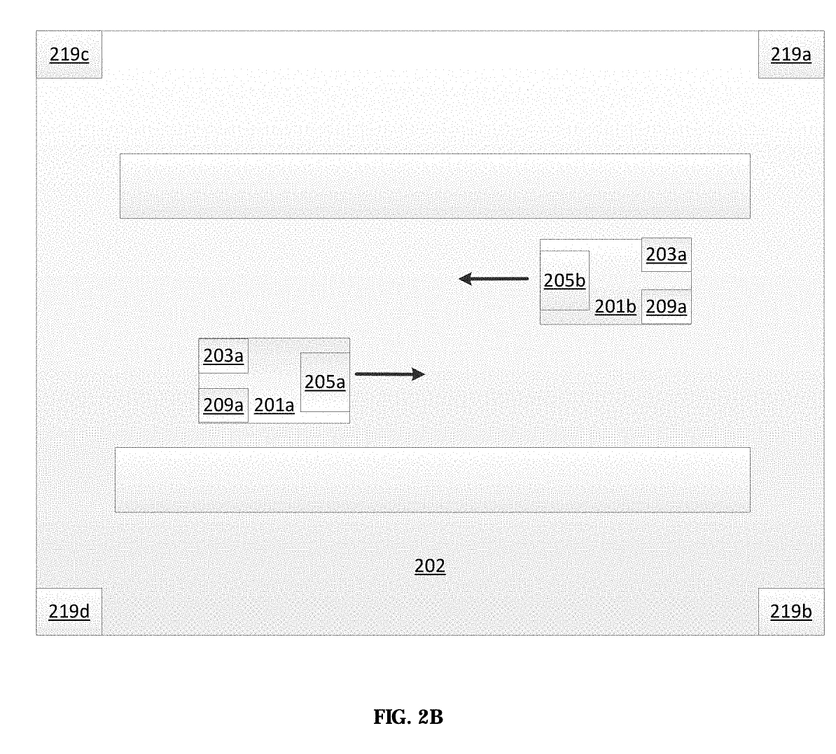

Referring now to FIGS. 2A-2B, a shopping cart communication system 200 includes a first shopping cart 201a and a second shopping cart 201b, each in electronic communication with a central server 213 having a memory 217 and a processor 214. The first and second shopping carts 201a, 201b can each, in accordance with various embodiments, include one or more of an operator terminal 203a, 203b for interfacing with an operator, a display device 205a, 205b for rendering images for display to the operator of a different one of the first or second shopping carts, the communication device 207a, 207b for communicating with the central server 213 or other carts 201a, 201b, and a location device 209a, 209b for determining a relative location of the first shopping cart 201a to the second shopping cart 201b. In accordance with various embodiments, the operator terminal 203a, 203b can be configured to interface with an operator device 215. In accordance with various embodiments, the location device 209a, 209b can be readable or identifiable by a cart tracking system 219 for tracking of each of the first and second carts 201a, 201b by the central server 213. In accordance with various embodiments, the first and second shopping carts do not include the location device 209a, 209b and the cart tracking system 219 can be configured to independently track a location and movement of the first and second shopping carts 201a, 201b. In accordance with various embodiments, the first and second shopping carts 201a, 201b can include a product identification device 211a, 211b for detecting placement of a product into a respective one of the first and second shopping carts 201a, 201b.

The first and second shopping carts 201a, 201b can, for example but without limitation, be similar to the first and second shopping carts 101a, 101b described above with reference to FIG. 1 and the shopping cart 301 described above with reference to FIG. 3. The operator terminal 203a, 203b can, for example but without limitation, be similar to the operator terminal 103a, 103b described above with reference to FIG. 1 and the operator terminal 303 described above with reference to FIG. 3. The display device 205a, 205b can, for example but without limitation, be similar to the display device 105a, 105b described above with reference to FIG. 1 and the display device 305 described above with reference to FIG. 3. The communications device 207a, 207b can, for example but without limitation, be similar to the communications device 107a, 107b described above with reference to FIG. 1. The location device 209a, 209b can, for example but without limitation, be similar to the location device 109a, 109b described above with reference to FIG. 1. The product identification device 211a, 211b can, for example but without limitation, be similar to the product identification device 111a, 111b described above with reference to FIG. 1. The operator device 215 can, for example but without limitation, be similar to the operator device 115 described above with reference to FIG. 1.

The central server 213, in accordance with various embodiments, can include, for example, a desktop computer, a laptop computer, a tablet, a smartphone, a server, a computing cloud, combinations thereof, or any other suitable device or devices capable of electronic communication with the first and second shopping carts 201a, 201b and having a processor 214 and a memory 217. Processor 214, in accordance with various embodiments can include, for example, but is not limited to, a microchip, a processor, a microprocessor, a special purpose processor, an application specific integrated circuit, a microcontroller, a field programmable gate array, any other suitable processor, or combinations thereof. Memory 217, in accordance with various embodiments can include, for example, but is not limited to, hardware memory, non-transitory tangible media, magnetic storage disks, optical disks, flash drives, computational device memory, random access memory, such as but not limited to DRAM, SRAM, EDO RAM, any other type of memory, or combinations thereof.

The cart tracking system 219, in accordance with various embodiments, can include, for example, an RFID system, a video surveillance system having image recognition capabilities, a motion sensor system, a proximity sensor system, a cellular triangulation system, a GPS tracking system, any other system or device suitable for detecting and tracking a movement of one or more shopping carts 201a, 201b, or combinations thereof. For example, as shown in FIG. 2B, the cart tracking system 219 can include a network of nodes 219a-d (e.g., RFID transceivers) distributed throughout a shopping environment 202 for detecting and tracking the location devices 209a, 209b (e.g., RFID tags) associated with each of the first and second shopping carts 201a, 201b. Thus, in use, the cart tracking system 219 can provide location data acquired by each of the nodes 219a-d from the location devices 209a, 209b to the central server 213, which can, using the processor 204, process the location data to identify a relative location and directionality of movement of each of the first and second shopping carts 201a, 201b.

In accordance with various embodiments, an operator of the first shopping cart 201a can input operator identifying information at the operator terminal 203a of the first shopping cart 201a to associate the first shopping cart 201a with the operator. The operator terminal 203a can, in response to receiving the operator identifying information, transmit, via the communications device 207a of the first shopping cart 201a, the operator identifying information to the central server 213. The central server 213, by the processor 214 then retrieves operator data associated with the operator from the memory 217. Operator data can include, for example, an electronic shopping list, operator purchase history, operator preferences, operator demographic information, operator appointment information, any other data associated with the operator of the first cart, or combinations thereof.

In accordance with various embodiments, the central server 213 can receive additional operator data from the operator terminal 203a. For example, in accordance with various embodiments, an operator can request to link an operator device 215 with the operator terminal 203a of the first shopping cart 201a and enter operator identifying information to associate the operator with the first shopping cart 201a. The operator terminal 203a can then, in accordance with various embodiments, retrieve a shopping list from the operator device 215 and transmit the shopping list to the central server 213.

The central server 213, in response to receiving operator identifying information, can also retrieve the location data (e.g., proximity and directionality of movement of each of the first and second shopping carts 201a, 201b) from the nodes 219a-d of the cart tracking system 219 to detect the second shopping cart 201b) approaching the first shopping cart 201a (and thus the operator) such that the display device 205b of the second shopping cart 201b is positioned to display a rendered image, notification, or message to the operator of the first shopping cart 201a.

The central server 213, based on the operator data and the relative location data, can automatically transmit instructions to the display device 205b of the second shopping cart 201b to display an image, notification, or message to the operator of the first shopping cart 201a. For example, the central server 213 can instruct the display device 205b of the second shopping cart 201b to display a message to the operator of the first shopping cart 201a indicating that a particular item on the operator's shopping list is located nearby, that a nearby item is on sale, providing operator-specific advertising, providing a status notification of an automotive repair, or any other imagery, notifications, or information.

Thus the system 200 advantageously permits the operator of the first shopping cart to receive an intended message from a display device 205b of the second shopping cart 201b, thereby permitting the operator to continue looking upward or outward. Therefore, the operator can remain focused on safe operation of the shopping cart and looking for products or items of interest, rather than looking down at an operator-facing display mounted on the first shopping cart 201a.

FIG. 3 illustrates an example shopping cart 301 having an operator terminal 303 and a display device 305 for use in accordance with various embodiments. The shopping cart 301 can, for example but without limitation, be similar to the first and second shopping carts 101a, 101b, 201a, 201b described above with reference to FIGS. 1 and 2. The operator terminal 303 can, for example but without limitation, be similar to the operator terminals 103a, 103b, 203a, 203b described above with reference to FIGS. 1 and 2. The display device 305 can, for example but without limitation, be similar to the display devices 105a, 105b, 205a, 205b described above with reference to FIGS. 1 and 2.

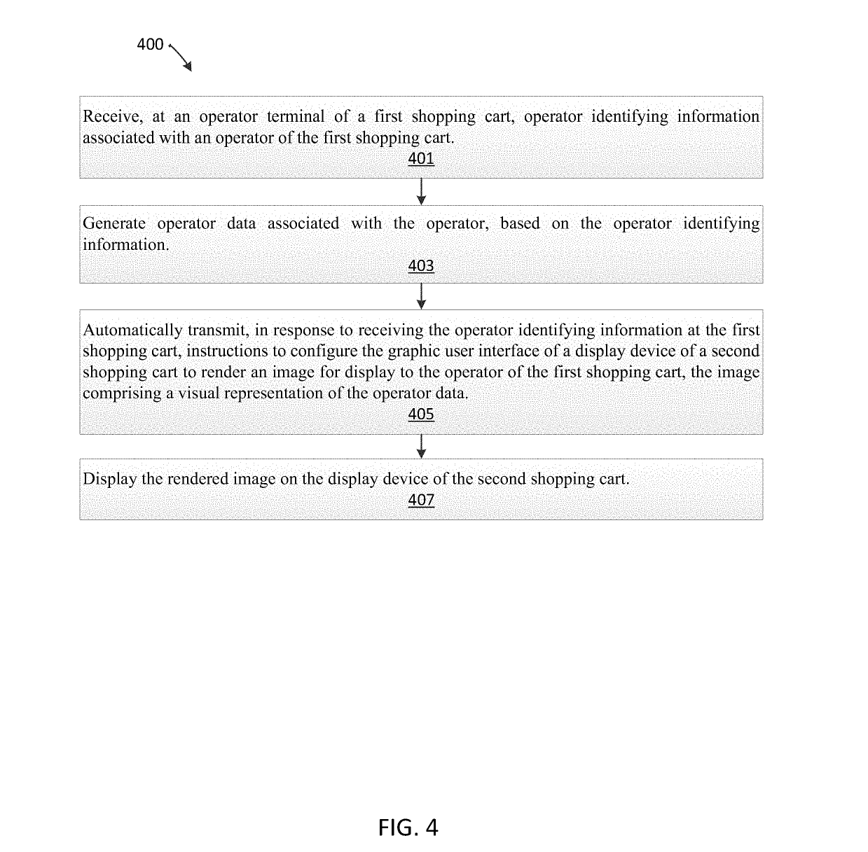

Referring now to FIG. 4, a method 400 is provided for operating a shopping cart communication system. The method includes a step 401 of receiving, at an operator terminal of a first shopping cart, operator identifying information associated with an operator of the first shopping cart. The method also includes a step 403 of generating operator data associated with the operator, based on the operator identifying information. The method also includes a step 405 of automatically transmitting, in response to receiving the operator identifying information at the first shopping cart, instructions to configure the graphic user interface of a display device of a second shopping cart to render an image for display to the operator of the first shopping cart, the image including a visual representation of the operator data. The method also includes a step 407 of displaying the rendered image on the display device of the second shopping cart.

The step 401 of receiving, at an operator terminal of a first shopping cart, operator identifying information associated with an operator of the first shopping cart can be performed, for example but not limited to, using the operator terminal 103a, 203a of the first shopping cart 101a, 201a to receive operator identifying information as described above with reference to FIGS. 1 and 2.

The step 403 of generating operator data associated with the operator, based on the operator identifying information can be performed, for example but not limited to, at least one of using the operator terminal 103a of the first shopping cart 101a to receive or retrieve operator data as described above with reference to FIG. 1 or using the processor 214 of the central server 213 to receive or retrieve operator data as described above with reference to FIG. 2.

The step 405 of automatically transmitting, in response to receiving the operator identifying information at the first shopping cart, instructions to configure the graphic user interface of a display device of a second shopping cart to render an image for display to the operator of the first shopping cart, the image including a visual representation of the operator data can be performed, for example but not limited to, using at least one of the operator terminal 103a of the first shopping cart 101a to transmit instructions to the display device 105b of the second shopping cart 101b as described above with reference to FIG. 1 or using the central server 213 to transmit instructions to the display device 205b of the second shopping cart 201b as described above with reference to FIG. 2.

The step 407 of displaying the rendered image on the display device of the second shopping cart can be performed, for example but not limited to, using the display device 105b, 205b of the second shopping cart 101b, 201b to receive operator identifying information as described above with reference to FIGS. 1 and 2.

### Exemplary Computing Devices

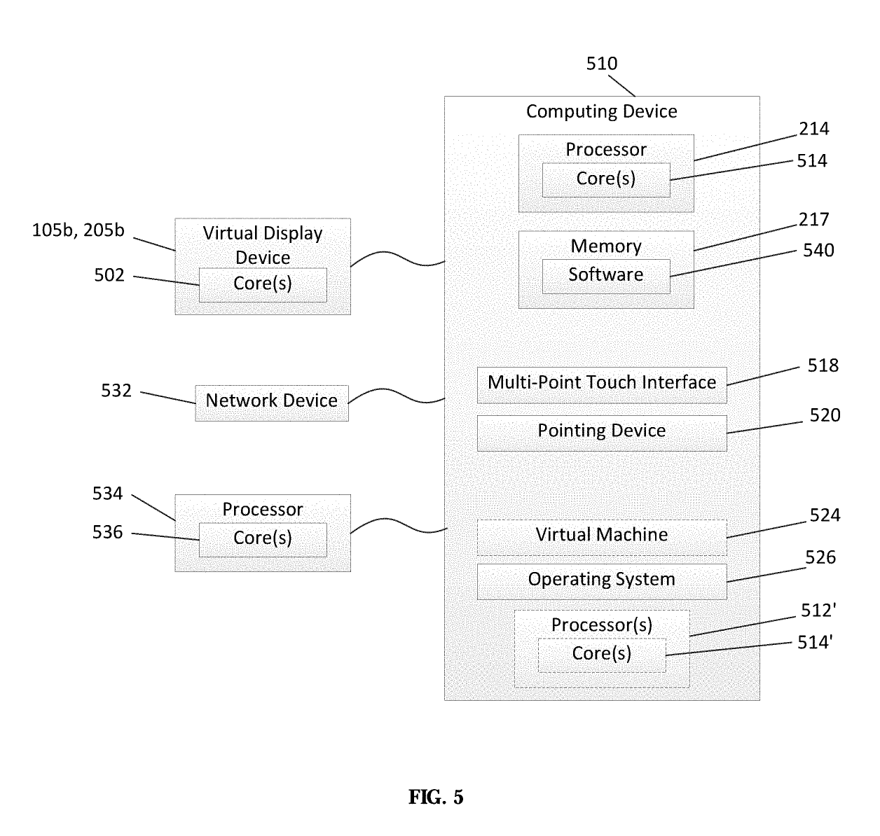

FIG. 5 is a block diagram of an exemplary computing device 510 such as can be used, or portions thereof, in accordance with various embodiments and, for clarity, refers back to and provides greater detail regarding various elements of the systems 100, 200 of FIGS. 1 and 2A-2B. The computing device 510 can include one or more non-transitory computer-readable media for storing one or more computer-executable instructions or software for implementing exemplary embodiments. The non-transitory computer-readable media can include, but are not limited to, one or more types of hardware memory, non-transitory tangible media (for example, one or more magnetic storage disks, one or more optical disks, one or more flash drives), and the like. For example, memory 217 included in the computing device 510 can store computer-readable and computer-executable instructions or software for performing the operations disclosed herein. For example, the memory 217 can store a software application 540 which is configured to perform various of the disclosed operations (e.g., generating operator data and transmitting instructions to the display device 105b, 205b of the second shopping cart 101, 201b based on operator data stored in the memory 217 and instructing the display device 105b, 205b of the second shopping cart 101, 201b to render imagery, notifications, or messages). The computing device 510 can also include configurable and/or programmable processor 214 and an associated core 514, and optionally, one or more additional configurable and/or programmable processing devices, e.g., processor(s) 512′ and associated core(s) 514′ (for example, in the case of computational devices having multiple processors/cores), for executing computer-readable and computer-executable instructions or software stored in the memory 217 and other programs for controlling system hardware. Processor 214 and processor(s) 512′ can each be a single core processor or multiple core (514 and 514′) processor.

Virtualization can be employed in the computing device 510 so that infrastructure and resources in the computing device can be shared dynamically. A virtual machine 524 can be provided to handle a process running on multiple processors so that the process appears to be using only one computing resource rather than multiple computing resources. Multiple virtual machines can also be used with one processor.

Memory 217 can include a computational device memory or random access memory, such as DRAM, SRAM, EDO RAM, and the like. Memory 217 can include other types of memory as well, or combinations thereof.

A user can interact with the computing device 510 through a visual display device 528, such as a computer monitor, which can display one or more user interfaces 530 that can be provided in accordance with exemplary embodiments. The computing device 510 can include other I/O devices for receiving input from a user, for example, a keyboard or any suitable multi-point touch interface 518, a pointing device 520 (e.g., a mouse). The keyboard 518 and the pointing device 520 can be coupled to the visual display device 528. The computing device 510 can include other suitable conventional I/O peripherals.

The computing device 510 can also include one or more storage devices 534, such as a hard-drive, CD-ROM, or other computer readable media, for storing data and computer-readable instructions and/or software that perform operations disclosed herein. Exemplary storage device 534 can also store one or more databases for storing any suitable information required to implement exemplary embodiments. The databases can be updated manually or automatically at any suitable time to add, delete, and/or update one or more items in the databases.

The computing device 510 can include a network interface 522 configured to interface via one or more network devices 532 with one or more networks, for example, Local Area Network (LAN), Wide Area Network (WAN) or the Internet through a variety of connections including, but not limited to, standard telephone lines, LAN or WAN links (for example, 802.11, T1, T3, 56 kb, X.25), broadband connections (for example, ISDN, Frame Relay, ATM), wireless connections, controller area network (CAN), or some combination of any or all of the above. The network interface 522 can include a built-in network adapter, network interface card, PCMCIA network card, card bus network adapter, wireless network adapter, USB network adapter, modem or any other device suitable for interfacing the computing device 510 to any type of network capable of communication and performing the operations described herein. Moreover, the computing device 510 can be any computational device, such as a workstation, desktop computer, server, laptop, handheld computer, tablet computer, or other form of computing or telecommunications device that is capable of communication and that has sufficient processor power and memory capacity to perform the operations described herein.

The computing device 510 can run any operating system 526, such as any of the versions of the Microsoft® Windows® operating systems, the different releases of the Unix and Linux operating systems, any version of the MacOS® for Macintosh computers, any embedded operating system, any real-time operating system, any open source operating system, any proprietary operating system, or any other operating system capable of running on the computing device and performing the operations described herein. In exemplary embodiments, the operating system 526 can be run in native mode or emulated mode. In an exemplary embodiment, the operating system 526 can be run on one or more cloud machine instances.

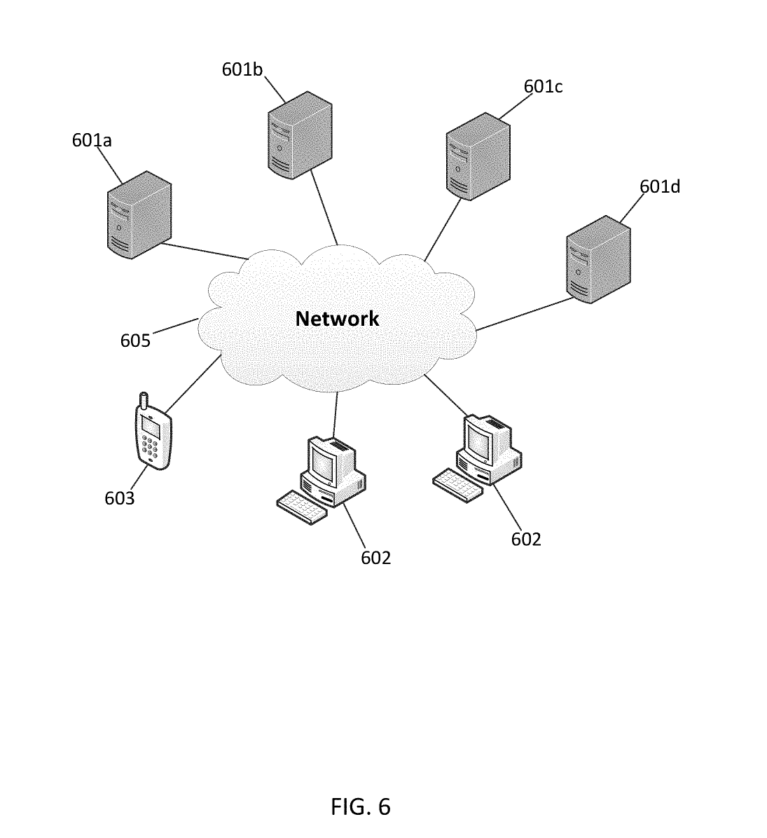

FIG. 6 is an example computational device block diagram of certain distributed embodiments. Although FIGS. 1 and 2, and portions of the exemplary discussion above, make reference to centralized systems 100, 200 or operating on a single central server 213, one will recognize that various of the modules within the systems 100, 200 may instead be distributed across a network 605 in separate server systems 601a-d and possibly in user systems, such as a desktop computer device 602, or mobile computer device 603. As one example, users may download an application to their desktop computer device or mobile computer device, which is configured to operate as the central server 213. As another example, the operator terminal 103a, 103b, 203a, 203b, 303 can be included in a client side application of a client-server environment, wherein the system 100, 200 is hosted by a server and interacted with by the desktop computer device or mobile device. In some distributed systems, the modules of the system 100, 200 can be separately located on server systems 601a-d and can be in communication with one another across the network 605.

In describing exemplary embodiments, specific terminology is used for the sake of clarity. For purposes of description, each specific term is intended to at least include all technical and functional equivalents that operate in a similar manner to accomplish a similar purpose. Additionally, in some instances where a particular exemplary embodiment includes a plurality of system elements, device components or method steps, those elements, components or steps may be replaced with a single element, component or step. Likewise, a single element, component or step may be replaced with a plurality of elements, components or steps that serve the same purpose. Moreover, while exemplary embodiments have been shown and described with references to particular embodiments thereof, those of ordinary skill in the art will understand that various substitutions and alterations in form and detail may be made therein without departing from the scope of the invention. Further still, other aspects, functions and advantages are also within the scope of the invention.

Exemplary flowcharts are provided herein for illustrative purposes and are non-limiting examples of methods. One of ordinary skill in the art will recognize that exemplary methods may include more or fewer steps than those illustrated in the exemplary flowcharts, and that the steps in the exemplary flowcharts may be performed in a different order than the order shown in the illustrative flowcharts.

What is claimed is:

1. A shopping cart communication system comprising:
a first shopping cart comprising an operator terminal; and
a second shopping cart in electronic communication with the operator terminal of the first shopping cart, the second shopping cart comprising a display device, and the display device comprising a graphic user interface;
wherein the operator terminal is configured to receive operator identifying information associated with an operator of the first shopping cart:
wherein, in response to receiving the operator identifying information, the operator terminal of the first shopping cart is configured to:
based on the operator identifying information, generate operator data associated with the operator; and
automatically transmit instructions to the display device of the second shopping cart to configure the graphic user interface to render an image for display to the operator of the first shopping cart, the image comprising a visual representation of the operator data.

2. The system of claim 1:
wherein the first shopping cart and the second shopping cart comprise first and second nodes of a distributed network, and
wherein a first communications device of the first shopping cart is configured to transmit the instructions to a second communications device of the second shopping cart via at least one additional node of the distributed network.

3. The system of claim 2, wherein the at least one additional node comprises at least one of a third shopping cart having a third communications device, a WiFi device, a central server, a Bluetooth device, a near-field communications device, or a cell site.

4. The system of claim 2, wherein the first and second communication devices are at least one of a radio frequency (RF) device, a WiFi device, a Bluetooth device, or a near-field communications (NFC) device;

5. The system of claim 1, wherein a first communications device of the first shopping cart is configured to transmit the instructions directly to a second communications device of the second shopping cart.

6. The system of claim 1, further comprising a central server in electronic communication with the first shopping cart and the second shopping cart, the central server being configured to transmit operator data associated with the operator of the first shopping cart to the operator terminal.

7. The system of claim 1, wherein the first shopping cart comprises a product identification device for identifying one or more products placed in the first shopping cart.

8. The system of claim 1, wherein the product identifying device is one or more of a radio frequency identification reader, a barcode scanner, or a weight sensor.

9. The system of claim 1, wherein the display device of the second shopping cart is coupled to at least one of a front vertical surface of the second shopping cart, a side vertical surface of the second shopping cart, or a mount extending from the second shopping cart.

10. The system of claim 1, wherein the first shopping cart comprises a location device for determining a relative location of the first shopping cart and the second shopping cart.

11. A shopping cart communication system comprising:
a central server comprising an operator database storing operator data associated with each of a plurality of operators;
a first shopping cart in electronic communication with the central server via a communications network, the first shopping cart comprising an operator terminal for interfacing with an operator of the plurality of operators; and
a second shopping cart in electronic communication with the central server, the second shopping cart comprising a display device, the display device comprising a graphic user interface,
wherein the operator terminal is configured to:
receive operator identifying information associated with the operator of the first shopping cart, and
transmit the operator identifying information to the central server,
wherein, in response to receiving the operator identifying information, the central server is configured to:
analyze operator data associated with the operator of the first shopping cart, and automatically transmit instructions, based on the analysis, to the display device of the second shopping cart to configure the graphic user interface to render an image for display to the operator of the first shopping cart, the image comprising a visual representation of the operator data.

12. The system of claim 11, wherein the operator terminal is configured to transmit at least a portion of the operator data to the central server by a first communications device of the first shopping cart.

13. The system of claim 11, wherein the first shopping cart comprises a product identification device for identifying one or more products placed in the first shopping cart.

14. The system of claim 11, wherein the display device of the second shopping cart is coupled to at least one of a front vertical surface of the second shopping cart, a side vertical surface of the second shopping cart, or a mount extending from the second shopping cart.

15. The system of claim 11, further comprising a cart tracking system in communication with the central server for determining a relative location, a movement speed, and a movement direction of the first shopping cart and the second shopping cart.

16. The system of claim 15, wherein the cart tracking system comprises at least one of a GPS locator, an RFID reader, a WiFi transceiver, a cellular transceiver, or a video analysis system.

17. A method for operating a shopping cart communication system comprising:
receiving, at an operator terminal of a first shopping cart, operator identifying information associated with an operator of the first shopping cart;
generating operator data associated with the operator, based on the operator identifying information;
automatically transmitting, in response to receiving the operator identifying information at the first shopping cart, instructions to configure the graphic user interface of a display device of a second shopping cart to render an image for display to the operator of the first shopping cart, the image comprising a visual representation of the operator data; and
displaying the rendered image on the display device of the second shopping cart.

18. The method of claim 17, further comprising:
automatically transmitting, in response to receiving the operator identifying information at the first shopping cart, the operator identifying information from the operator terminal of the first shopping cart to a central server in electronic communication with the first and second shopping carts,
wherein the instructions are automatically transmitted from the central server to the display device.
